(19) United States
(12) Patent Application Publication
(10) Pub. No.: US 2006/0092665 A1
(43) Pub. Date: May 4, 2006

(54) Light emitting diode and backlight apparatus having the same

(75) Inventors: Chang Wook Kim, Anyang (KR); Young Jae Soung, Suwon (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Samsung Electro-Mechanics Co., Ltd., Suwon (KR)

(21) Appl. No.: 11/064,969

(22) Filed: Feb. 25, 2005

(30) Foreign Application Priority Data
Nov. 2, 2004 (KR) 10-2004-88364

(51) Int. Cl. F21V 7/04

(52) U.S. Cl. 362/612

(57) ABSTRACT

An LED and an LCD backlight apparatus having the same. In the LED, a lower side wall projected from the LED between and beyond LED terminals, such that the bottom of an LED window in the vicinity of the lower side wall is positioned flush with or under the terminals, and a recess is formed in a board of the backlight apparatus to receive the lower side wall. The height of the LED mounted on the backlight apparatus can be reduced and light efficiency can be improved.

### RELATED APPLICATION

The present application is based on and claims priority from Korean Application Number 10-2004-0088364, filed Nov. 2, 2004, the disclosure of which is hereby incorporated by reference herein in its entirety.

### BACKGROUND OF THE INVENTION

1. Field of the Invention

The present invention relates to a Light Emitting Diode (LED) and a backlight apparatus having the same, and more particularly, in which a side wall of the LED is projected between and beyond terminals thereof and a recess for receiving the side wall is formed in a board of the backlight apparatus in order to improve light efficiency as well as reduce the height of the LED mounted on the backlight apparatus.

2. Description of the Related Art

A Liquid Crystal Display (LCD) backlight apparatus of a mobile communication device has a general structure as shown in FIG. 1. That is, the backlight apparatus 10 has a planar light guide plate 14 placed on a board 12 and an array of LEDs 20 placed by the side of the light guide plate 14. Generally, the LED array includes a plurality of LEDs 20. Light from the LED 20 is introduced into the light guide plate 14, reflected upward by a minute reflective pattern and/or a reflective sheet 16 placed on the underside of the light guide plate 14, and emitted outward from the light guide plate 14 in order to backlight an LCD panel 18 placed above the light guide plate 14.

FIG. 2 is a front elevation view illustrating a conventional LED 20 as shown in FIG. 1. Referring to FIG. 2, the LED 20 includes an LED body 22 having a cup-shaped cavity 28 that houses an LED chip 32 (cf. FIG. 4) therein. The LED body 22 also has upper and lower walls 24 and side walls 26 surrounding the cup-shaped cavity 28. The cup-shaped cavity 28 is opened upward from the plane of FIG. 2 forming an LED window to introduce light from the LED chip to the outside, and transparent resin is filled into the cavity 28 to seal the LED chip from the outside. Transparent resin may contain fluorescent material to convert monochromatic light from the LED chip into white light. In addition, a pair of terminals 30 are mounted at both lateral sides of the body 22 to electrically connect the LED chip with an external power source.

FIG. 3 is a front elevation view illustrating another conventional LED. Referring to FIG. 3, an LED 20A includes an LED body 22 having a cup-shaped cavity 28 that houses an LED chip 32 (cf. FIG. 4) therein. In the LED 20A shown in FIG. 3, the LED body 22 surrounding body 28 has thin upper and lower side walls 24a confining upper and lower boundaries of the cavity 28 and relatively thick side walls 26a confining right and left boundaries of the cavity 28. In addition, terminals 30 are attached to the side walls 26a, respectively.

This configuration can reduce the thickness of the entire LED 20 since the terminals 30 are not overlapped with the cavity 28. In particular, reduction in LED thickness is also advantageous to LCD backlight apparatuses since currently there is demand to reduce the thickness of the LCD backlight apparatuses. At present, it is required to reduce the thickness of a side-type LED in use for an LCD backlight up to about 0.6 mm. It is expected that there will be demand to reduce the thickness up to about 0.5 mm or less in the future.

However, the afore-described LEDs 20 and 20A as shown in FIGS. 2 and 3 can hardly achieve a package thickness or mounting thickness of about 0.5 mm or less since the opening of the cavity 28 as an LED window should have at least a predetermined width to guide light from the LED chip 32 to the outside and the upper and lower side walls 24 and 24a of the LED window also should have at least a predetermined thickness to impart a desired strength to the LED.

Reference will now be made to a problem found in an LCD backlight apparatus adopting such conventional LEDs in conjunction with FIG. 4. As shown in FIG. 4, the opening of the cavity 28 as an LED window is spaced upward from the underside of a light guide plate 14 to the thickness t of the lower side wall 24. Accordingly, when emitted downward out of the cavity 28, light L from the LED chip 32 propagates a predetermined length to reach the reflective sheet 16 underlying the light guide plate 14. This as a result creates a dark area 34 to exist in a portion of the reflective sheet 16 where light L is faint, thereby lowering the efficiency of the entire LCD backlight apparatus.

Furthermore, according to the miniaturization of a mobile communication device, the light guide plate mounted on the LCD backlight apparatus also tends to decrease in thickness. That is, the light guide plate of the LCD backlight apparatus is decreasing in thickness up to 0.5 mm or less.

The LCD backlight apparatus adopting conventional LEDs suffer from a following problem, which will be described with reference to FIG. 5. As shown in FIG. 5, where a light guide plate 14a has a thickness of about 0.5 mm or less, an LED 20, 20A has a thickness larger than that of the light guide plate 14a, such that a considerable quantity of light from the LED chip 32 (cf. FIG. 4) of the LED 20, 20A is not introduced into the light guide plate 14a thereby causing light loss. Accordingly, a reflector 36 is installed in a top lateral portion of the light guide plate 14a of the LCD backlight apparatus 10A in order to introduce light into the light guide plate 14a thereby preventing light loss.

However, this also causes a drawback adding complexity to both the LCD backlight apparatus 10A and its fabrication process, thereby increasing process time and cost.

### SUMMARY OF THE INVENTION

The present invention has been made to solve the foregoing problems of the prior art and it is therefore an object of the present invention to provide an LED and an LCD backlight apparatus having the same, in which a lower side wall is projected from the LED between and beyond LED terminals, such that the bottom of an LED window in the vicinity of the lower side wall is positioned flush with or under the terminals, and a recess is formed in a board of the backlight apparatus to receive the lower side wall in order to reduce the height of the LED mounted on the backlight apparatus.

It is therefore an object of the present invention to provide an LED and an LCD backlight apparatus having the same, in which in which a lower side wall is projected from the LED between and beyond LED terminals, such that the bottom of an LED window in the vicinity of the lower side wall is positioned flush with or under the terminals, and a recess is formed in a board of the backlight apparatus to receive the lower side wall in order to improve light efficiency.

According to an aspect of the invention for realizing the object, there is provided an LED in an LCD backlight apparatus, which includes a board, a light guide plate placed on the board and the LED placed by the side of the light guide plate, the LED comprising: an LED chip; an LED body having a cup-shaped cavity opened toward the light guide plate and side walls surrounding the cavity to house the LED chip therein while guiding light from the LED chip into the light guide plate; a transparent encapsulant for sealing the cup-shaped cavity and the LED chip; and terminals placed at a side of the LED body, wherein the side walls have a lower portion projected downward beyond the terminals.

Preferably, the board may have a recess formed adjacent to the light guide plate to receive the lower portion of the LED body.

According to another aspect of the invention for realizing the object, there is provided an LCD backlight apparatus comprising: a board having recesses formed in predetermined positions; a light guide plate placed on the board adjacent to the recesses; and LEDs placed by the side of the light guide plate and partially received by the recesses, respectively, wherein each of the LEDs comprises an LED chip, an LED body having a cup-shaped cavity opened toward the light guide plate and side walls surrounding the cavity to house the LED chip therein while guiding light from the LED chip into the light guide plate, a transparent encapsulant for sealing the cup-shaped cavity and the LED chip and terminals placed at a side of the LED body, and wherein the side walls have a lower portion projected downward beyond the terminals.

The LCD backlight apparatus may further comprise a reflective sheet interposed between the board and the light guide plate.

In the LED or the LCD backlight apparatus having the same, the terminals may be placed at the same side or opposite lateral portions of the LED body.

In the LED or the LCD backlight apparatus having the same, the side walls may have an upper portion opposed to the lower portion, the upper portion having a thickness of about 0.05 to 0.1 mm.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a side elevation view illustrating a conventional backlight apparatus;

FIG. 2 is a front elevation view illustrating a conventional LED;

FIG. 3 is a front elevation view illustrating another conventional LED;

FIG. 4 is a vertical cross-sectional view illustrating a problem of an LCD backlight apparatus adopting a conventional LED;

FIG. 5 is a side elevation view illustrating another problem of an LCD backlight apparatus adopting a conventional LED;

FIG. 6 is a front elevation view illustrating a preferred embodiment of an LED according to the invention;

FIG. 7 is a side elevation view of the LED shown in FIG. 6;

FIG. 8 is a vertical cross-sectional view of the LED shown in FIG. 6;

FIG. 9 is a perspective view schematically illustrating an LCD backlight apparatus mounted with LEDs according to the invention;

FIG. 10 is a front elevation view illustrating an LED mounted on an LCD backlight apparatus according to the invention;

FIG. 11 is a side elevation view schematically illustrating an LCD backlight apparatus according to the invention; and

FIG. 12 is a vertical cross-sectional view illustrating merits of an LCD backlight apparatus according to the invention.

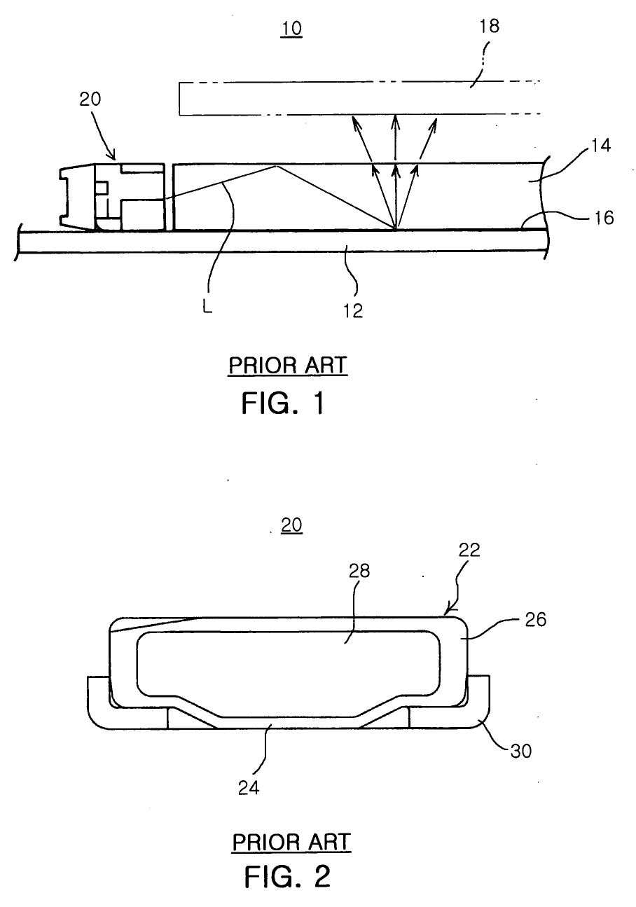

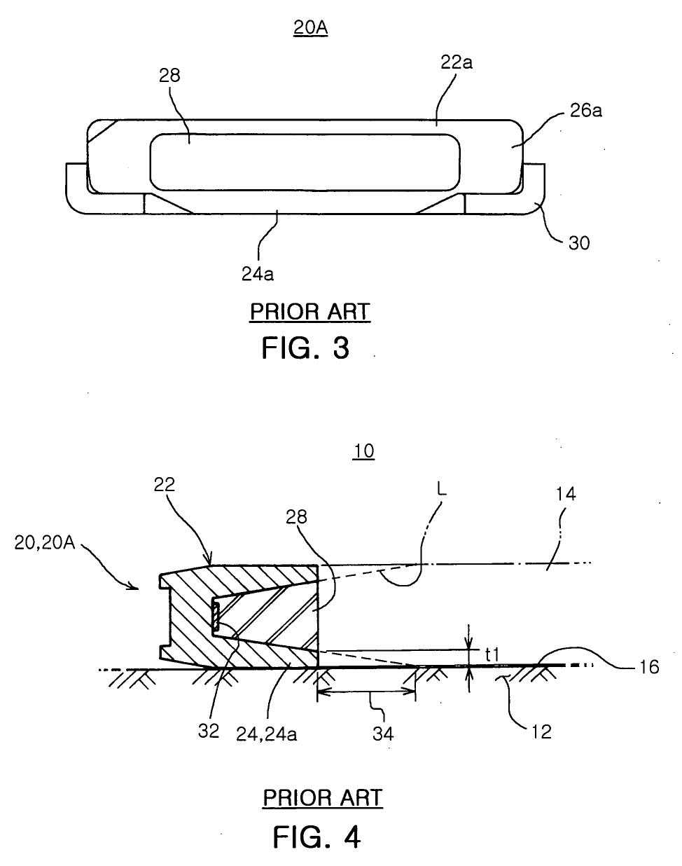

### DETAILED DESCRIPTION OF THE PREFERRED EMBODIMENT

The following detailed description will present preferred embodiments of the present invention with reference to the accompanying drawings.

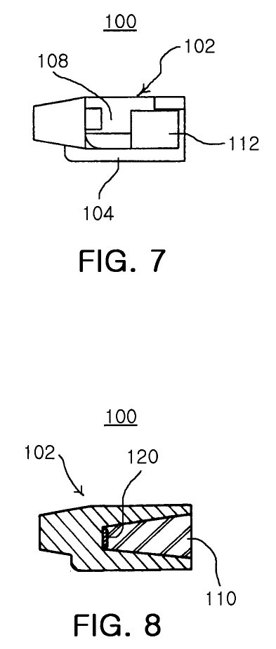

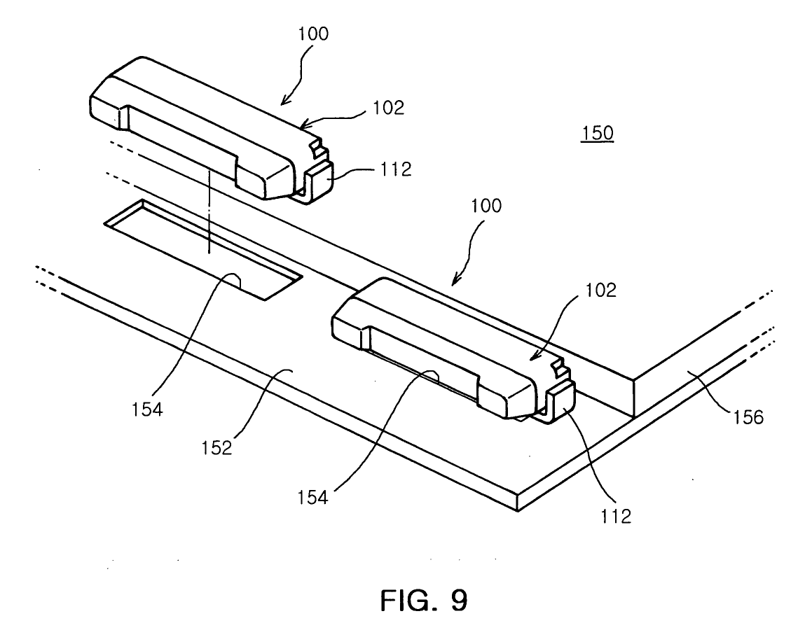

First a preferred embodiment of an LED according to the invention will be described with reference to FIGS. 6 to 8, in which FIG. 6 is a front elevation view illustrating a preferred embodiment of an LED according to the invention, FIG. 7 is a side elevation view of the LED shown in FIG. 6, and FIG. 8 is a vertical cross-sectional view of the LED shown in FIG. 6.

As shown in FIGS. 6 to 8, an LED 100 includes an LED chip 120, a package body or LED body 102 having a cup-shaped cavity 110, which houses the LED chip 120 therein, and a pair of terminals 112 attached to projections 108 at opposite lateral portions of the LED body 102 to electrically connect the LED chip 120 with an external power source.

The cup-shaped cavity 110 is opened upward from the plane of FIG. 6 forming an LED window to introduce light from the LED chip 120 therein into an outside light guide plate 156 (cf. FIG. 9), and transparent resin is filled into the cavity 110 to seal the LED chip 120 from the outside. In case that the LED chip 120 in the cavity 110 generates monochromatic light, transparent resin may contain specific fluorescent material to convert monochromatic light into white light.

The LED body 102 has a lower side wall 104 projected downward together with the cavity 110 to a length substantially equal with the thickness of the lower side wall 104, in such a fashion that the underside of the terminals 112 attached to the underside of the lateral projections 108 is positioned substantially flush with or higher than the bottom of the LED window defined by the cavity 110.

In addition, since the lower side wall 104 and lateral projections 108 are formed thick, the thickness of an upper side wall 106 can be reduced to a relatively small value while maintaining the strength of the entire LED 100 at a required value or more. That is, the thickness of the upper side wall 106 may be reduced up to 0.1 mm or even to 0.05 mm, which is regarded as a thickness limit achievable by molding. Such additional reduction in the thickness of the upper side wall 106 can also reduce the thickness or height of the LED 100 in a mounted position.

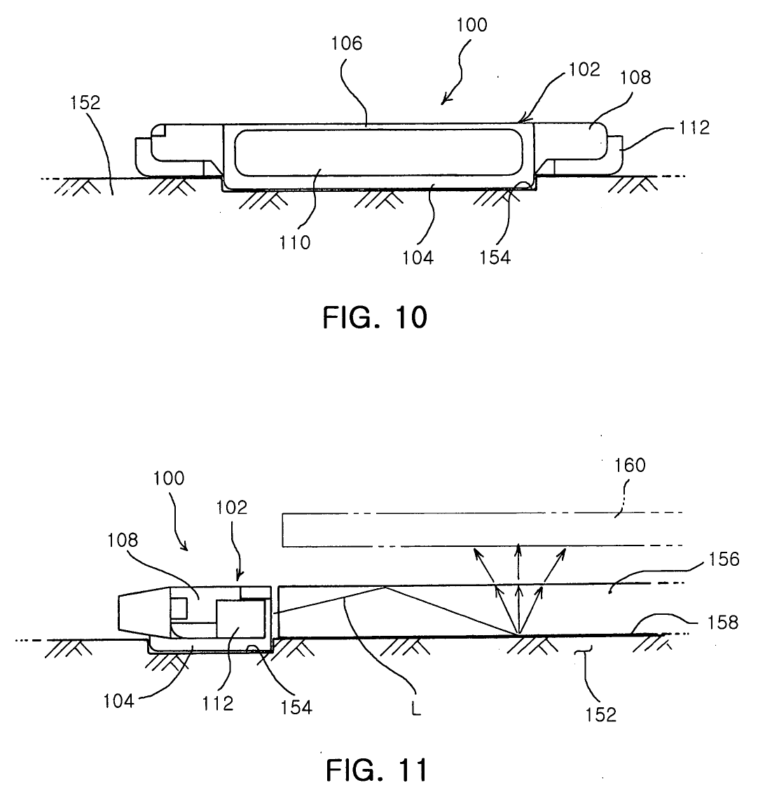

Reference will now be made to an LCD backlight apparatus mounted with LEDs (as described above with reference to FIGS. 6 to 8 above) according to the invention in conjunction with FIGS. 9 to 11, in which FIG. 9 is a perspective view schematically illustrating the LCD backlight apparatus mounted with LEDs according to the invention, FIG. 10 is a front elevation view illustrating an LED mounted on the LCD backlight apparatus according to the invention, and FIG. 11 is a side elevation view schematically illustrating the LCD backlight apparatus according to the invention.

As shown in FIGS. 9 to 11, an LCD backlight apparatus 150 of the invention includes a planar board 152, a planar light guide plate 156, a thin reflective sheet 158 interposed between the board 152 and the light guide plate 156 and a plurality of LEDs 100 placed at a side of the light guide plate 156 to emit light into the light guide plate 156.

In this case, a reflective pattern may be formed in the underside of the light guide plate 156 or the top of the reflective sheet 158 to enhance the uniformity of light within the light guide plate 156.

The board 152 has recesses 154 formed adjacent to the light guide plate 156 to receive lower side walls 104 of the LEDs 100. The recesses 154 are formed at a depth corresponding to at least the thickness of the lower side walls 104, such that when the LEDs 100 are mounted on the board 152 (that is, the lower side walls 104 of the LEDs 100 are received in the recesses 154), the bottom of the LED windows of the cavities 110 are positioned flush with or under the top surface of the board 152.

This can reduce the mounting height of the LEDs 100 corresponding to the thickness of the lower side walls 104 inserted into the recesses 154, thereby enabling a mounting height of 0.5 mm or less that is not achievable in the prior art. This as a result can reduce the thickness of the LCD backlight apparatus mounted with the LEDs 100.

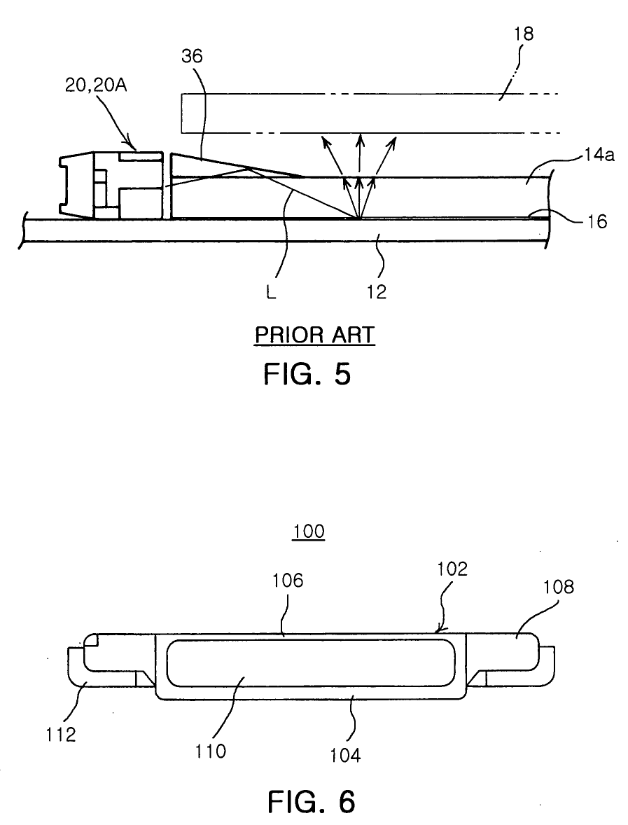

In addition, since the thickness of the light guide plate 156 is reduced to 0.5 mm or less according to the reduced mounting height of the LEDs 100, the problem of the prior art as in FIG. 5 does not take place any longer, and thus the top portion of the LED is not projected over the light guide plate. Specifically, the top of the LED window formed by the cavity 110 does not project over the light guide plate 156. In this way, light L from the LED chip 120 can be totally introduced into the light guide plate 156 without additional components such as the reflector 36 as in FIG. 5.

When introduced into the light guide plate 156, light L uniformly disperses within the light guide plate 156 and reflects upward from the reflective sheet 158 underlying the light guide plate 156 so as to reach and backlight the LCD panel 160 placed above the backlight apparatus 150.

Alternatively, the side projections 108 and the terminals 112 may be provided at a side portion of the LED body 102 unlike those shown in FIGS. 6 to 8. For example, the side projections 108 and the terminals 112 may be formed at a right portion of the LED body 102 in FIG. 6 or at a rear portion of the LED body 102 in FIG. 7.

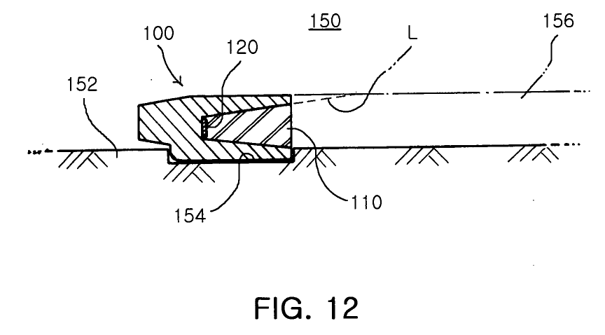

Now other advantages of the LCD backlight apparatus 150 mounted with the LEDs 100 according to the invention will be described with reference to FIG. 12. As shown in FIG. 12, when each LED 100 is mounted on the board 152, the lower side wall 104 of the LED 100 is received in each recess 154 of the board 152, such that the bottom of the LED window formed by the cavity 110 is positioned substantially flush with or under the top surface of the board 152. Therefore, the bottom of the LED window also becomes substantially flush with or under the underside of the light guide plate 156 overlying the board 152.

In this way, light L from the LED chip 120 is directly incident onto a bottom portion of the light guide plate 156 adjacent to the LED 100, such that the dark area 34 of the prior art as shown in FIG. 4 does not take place any longer in the light guide plate 156 of the LCD backlight apparatus of the invention.

Therefore, light uniformity can be increased through the entire area of the light guide plate 156. In addition, while the prior art wastes an area corresponding to the dark area 34 of the light guide plate 14, the present invention can equally utilize the whole area of the light guide plate 156. Therefore, even though the total area of the light guide plate 156 of the invention is reduced corresponding to the dark area of the prior art, the light guide plate 156 of the invention can provide the same entire backlight area as the conventional backlight apparatus. This as a result can reduce the dimension of the LCD backlight apparatus 150, thereby facilitating the miniaturization of an LCD that uses the LCD backlight apparatus 150.

In addition, while a pair of LEDs have been illustrated through the description of the LEDs and the LCD backlight apparatus of the invention, this is an example only, but three or more LEDs can be adopted. Of course, a single LED can realize the object of the invention when mounted on a very small LCD.

In the meantime, the invention can suitably use a white LED, e.g., an LED emitting white light. Since a combination of RGB LEDs which emit RGB light rays, respectively, used in a light guide plate to form white light increases the total size of the light guide plate, emitting white light from a single LED is advantageous to a small sized LCD. In this case, monochromatic light for example blue light can be converted into white light (natural light) by adding fluorescent material into resin in the cavity 110. Alternatively, a combination of RGB LED chips can be mounted within the LED body 102 to produce white light.

Of course, since monochromatic light such as blue, green and yellow light can be provided to the backlight apparatus, a single monochromatic LED or a plurality of monochromatic LEDs of the same color can be used in this event.

According the invention as described hereinbefore, a lower side wall is projected from an LED between and beyond LED terminals, such that the bottom of an LED window in the vicinity of the lower side wall is positioned flush with or under the terminals, and a recess is formed in a board of a backlight apparatus to receive the lower side wall in order to reduce the height of the LED mounted on the backlight apparatus.

Furthermore, since the mounting height of the LED can be decreased beyond the limit achievable by the prior art, the LED and the LCD backlight apparatus having the same according to the invention can be used advantageously, and especially, in an LCD of a small-sized device such as a mobile communication terminal and a Personal Digital Assistant (PDA).

While the present invention has been shown and described in connection with the preferred embodiments, it will be apparent to those skilled in the art that modifications and variations can be made without departing from the spirit and scope of the invention as defined by the appended claims.

What is claimed is:

1. A Light Emitting Diode (LED) in an LCD backlight apparatus, which includes a board, a light guide plate placed on the board and the LED placed by the side of the light guide plate, the LED comprising:
an LED chip;
an LED body having a cup-shaped cavity opened toward the light guide plate and side walls surrounding the cavity to house the LED chip therein while guiding light from the LED chip into the light guide plate;
a transparent encapsulant for sealing the cup-shaped cavity and the LED chip; and
terminals placed at a side of the LED body,
wherein the side walls have a lower portion projected downward beyond the terminals.

2. The LED according to claim 1, wherein the board has a recess formed adjacent to the light guide plate to receive the lower portion of the LED body.

3. The LED according to claim 1, wherein the terminals are placed at the same side of the LED body.

4. The LED according to claim 1, wherein the terminals are placed at opposite lateral portions of the LED body.

5. The LED according to claim 1, wherein the side walls have an upper portion opposed to the lower portion, the upper portion having a thickness of about 0.05 to 0.1 mm.

6. An LCD backlight apparatus comprising:
a board having recesses formed in predetermined positions;
a light guide plate placed on the board adjacent to the recesses; and
Light Emitting Diodes (LEDs) placed by the side of the light guide plate and partially received by the recesses, respectively,
wherein each of the LEDs comprises an LED chip, an LED body having a cup-shaped cavity opened toward the light guide plate and side walls surrounding the cavity to house the LED chip therein while guiding light from the LED chip into the light guide plate, a transparent encapsulant for sealing the cup-shaped cavity and the LED chip and terminals placed at a side of the LED body, and
wherein the side walls have a lower portion projected downward beyond the terminals.

7. The LCD backlight apparatus according to claim 6, wherein the terminals are placed at the same side of the LED body.

8. The LCD backlight apparatus according to claim 6, wherein the terminals are placed at opposite lateral portions of the LED body.

9. The LCD backlight apparatus according to claim 6, wherein the side walls have an upper portion opposed to the lower portion, the upper portion having a thickness of about 0.05 to 0.1 mm.

10. The LCD backlight apparatus according to claim 6, further comprising a reflective sheet interposed between the board and the light guide plate.

11. The LCD backlight apparatus according to claim 6, wherein the terminals are provided at a side of the LED body to electrically connect the LEC chip with an external power source, and have bottoms placed flush with or under the opening of the cavity.

12. The LED according to claim 1, wherein the terminals are provided at a side of the LED body to electrically connect the LEC chip with an external power source, and have bottoms placed flush with or under the opening of the cavity.
